(19) United States
(12) Patent Application Publication
(10) Pub. No.: US 2023/0041498 A1
(43) Pub. Date: Feb. 9, 2023

(54) Driver Assistance Systems And Methods For Deployment In A Drive-Through Lane

(71) Applicant: Ford Global Technologies, LLC, Dearborn, MI (US)

(72) Inventors: Keith Weston, Canton, MI (US); Andrew Lewandowski, Sterling Heights, MI (US); Brendan Diamond, Grosse Pointe, MI (US); Michael Alan McNees, Flat Rock, MI (US); Jordan Barrett, Milford, MI (US)

(21) Appl. No.: 17/394,291

(22) Filed: Aug. 4, 2021

(51) Int. Cl. B60W 60/00; B60W 30/09; B60W 30/18; H04W 4/021

(52) U.S. Cl. CPC B60W 60/0015; B60W 30/09; B60W 30/18018; H04W 4/021; B60W 2552/53; B60W 2510/20; B60W 2510/0638

(57) ABSTRACT

The disclosure generally pertains to systems and methods for assisting a driver to travel through a drive-through lane of an establishment in an autonomous mode of operation. In an example method, a processor in a vehicle determines a location of the vehicle in a drive-through lane in various ways such as, for example, based on objects located in the vicinity of the drive-through lane, based on location coordinates, and/or based on a geofence defined around the establishment. The processor may then place the vehicle in an autonomous mode of operation and instruct the driver of the vehicle to refrain from touching vehicle driving control components such as the steering wheel, the brake pedal, and the accelerator pedal. The vehicle autonomously then moves through the drive-through lane in a stop-and-go mode of movement at a controlled speed while executing lane-centering and collision avoidance.

### BACKGROUND

Establishments such as restaurants and convenience stores often include a drive-through lane that may be used by customers to order, pay for, and pick up various types of items. The drive-through lane is intended to provide convenient and speedy service. However, some drivers may prefer to spend their time performing various other activities rather than going through the tedious routine of keeping an eye out for a vehicle ahead of their own, braking, and moving forward intermittently in a drive-through lane. It is therefore desirable to provide a solution that addresses this issue.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes a driver assistance system configured to communicate with various devices in accordance with an embodiment of the disclosure.

FIG. 2 illustrates an example scenario where a vehicle travels through a drive-through lane in accordance with an embodiment of the disclosure.

FIG. 3 illustrates another example scenario where a vehicle travels through a drive-through lane in accordance with an embodiment of the disclosure.

FIG. 4 shows some example components that may be included in a vehicle that includes a driver assistance system in accordance with an embodiment of the disclosure.

### DETAILED DESCRIPTION

Overview

In terms of a general overview, certain embodiments described in this disclosure are directed to systems and methods for assisting a driver to travel through a drive-through lane of an establishment in a hands-off driving mode of operation. In an example method, a vehicle determines a location of the vehicle in a drive-through lane in various ways such as, for example, based on objects located in the vicinity of the drive-through lane, based on location coordinates, and/or based on a geofence defined around the establishment. The vehicle may then be placed in a hands-off driving mode of operation and instruct the driver of the vehicle to refrain from touching vehicle driving control components such as the steering wheel, the brake pedal, and the accelerator pedal. The vehicle may autonomously move through the drive-through lane in a stop-and-go mode of movement at a controlled speed while executing lane-centering and collision avoidance.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the described example embodiments but should be defined only in accordance with the claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. More particularly, it must be understood that the description with respect to battery charging stations in a battery charging lot does not in any way preclude implementation of the disclosure upon battery charging stations that are located elsewhere, such as, for example, in a parking space of a private or a public entity.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used in this disclosure encompasses various types of vehicles such as, for example, a sedan, a sports utility vehicle, a truck, a van, a bus, a driver-operated vehicle, a semi-autonomous vehicle, or an autonomous vehicle. Words such as “instruction,” or “advisory,” as used herein refers to any of various forms of communication such as, for example, a message displayed on a display screen of a device that is either a part of a vehicle or carried by a person, a voice instruction issued through a speaker of a device, a voice input to a microphone in a device. In one case, the advisory may instruct a driver of a vehicle to perform certain operations and/or to refrain from performing certain other operations. The word “image” as used herein can be a standalone digital image or an image that is a part of a video clip or video stream.

It must be understood that words such as “implementation,” “scenario,” “case,” “application,” “procedure,” and “situation” are shortened versions of phrases that include either of the following suffixes: “in accordance with the disclosure,” or “in accordance with an embodiment of the disclosure.” It should be understood that the word “example” as used herein is intended to be non-exclusionary and non-limiting in nature.

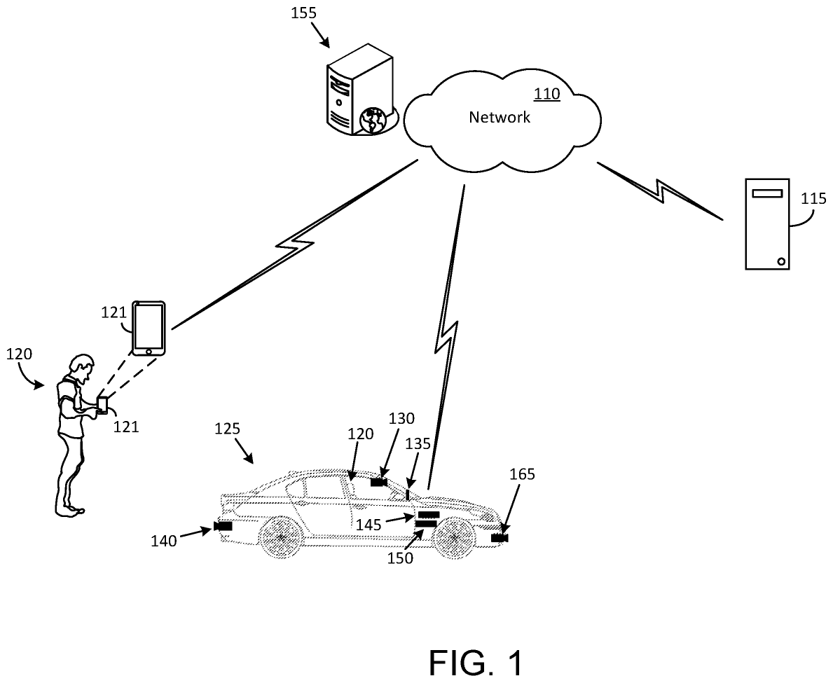

FIG. 1 illustrates an example vehicle 125 that includes a driver assistance system 150 configured to communicate with various devices in accordance with an embodiment of the disclosure. In an example embodiment, the driver assistance system 150 includes a computer that is located in a vehicle 125. In another example embodiment, the driver assistance system 150 includes a computer that is located outside a vehicle 125, such as, for example, in a personal communication device 121 of a driver 120 of the vehicle 125, a server computer 115, or a cloud computer 155.

The vehicle 125 may be any of various types of vehicles such as, for example, a sedan, a sports utility vehicle, a truck, a van, a driver-operated vehicle, a semi-autonomous vehicle, or an autonomous vehicle. In the illustrated example, the vehicle 125 is operated by a driver 120. In another example, the vehicle 125 is an autonomous vehicle. The vehicle 125 can include components such as, for example, a vehicle computer 145, an infotainment system 135, the driver assistance system 150, and various sensors and detection devices that are included in a sensor system provided in the vehicle 125.

The vehicle computer 145 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.).

In the illustrated scenario, the driver assistance system 150 is configured to execute various functions associated with assisting the driver 120 carry out a transaction in a drive-through lane of an establishment. The establishment can, for example, be a fast-food restaurant, and the transaction can be related to purchase of a fast-food item by use of the drive-through lane. The various functions executed by the driver assistance system 150 can include autonomously driving the vehicle 125 through the drive-through lane in a stop-and-go movement mode with no involvement of the driver 120 (no touching of the steering wheel, brake, accelerator, etc.). In another scenario where the vehicle 125 is an autonomous vehicle, the driver assistance system 150 is configured to execute various functions associated with assisting an occupant of the autonomous vehicle execute a transaction in a drive-through lane of an establishment by autonomously driving the autonomous vehicle in a stop-and-go movement mode through the drive-through lane.

As a part of the configuration, the driver assistance system 150 may be communicatively coupled to the vehicle computer 145 and/or the infotainment system 135 via wired and/or wireless connections. More particularly, in one implementation, the driver assistance system 150 is communicatively coupled to the vehicle computer 145 and the infotainment system 135 via a vehicle bus that uses a controller area network (CAN) bus protocol, a Media Oriented Systems Transport (MOST) bus protocol, and/or a CAN flexible data (CAN-FD) bus protocol. In another implementation, the driver assistance system 150 may be provided in the server computer 115 and/or the cloud computer 155, which are configured to communicate with the vehicle computer 145 and/or the infotainment system 135 via wireless technologies such as Wi-Fi, Ultra-Wideband (UWB), or cellular communications. In yet another implementation, the driver assistance system 150 may be provided in the personal communication device 121 and may communicate with the vehicle computer 145 and/or the infotainment system 135 via wireless technologies such as Bluetooth®, Ultra-Wideband (UWB), cellular, Wi-Fi, Zigbee®, or near-field-communications (NFC).

The infotainment system 135 can include elements such as, for example, a radio, an MP3 player, a global positioning system (GPS) device, a clock, and a display screen. The infotainment system 135 can further include a graphical user interface (GUI) or a human machine interface (HMI) that is displayed on the display screen. The GUI or HMI accepts input from an occupant of the vehicle 125 (the driver 120, for example), and/or displays various items pertaining to operations related to driving through a drive-through lane in accordance with the disclosure. An example item that may be displayed on the display screen of the infotainment system 135 can be an advisory provided by the driver assistance system 150 instructing the driver 120 to refrain from touching driving control components of the vehicle 125 such as, for example, a steering wheel of the vehicle 125, a brake pedal of the vehicle 125, and an accelerator pedal of the vehicle 125.

The driver assistance system 150 may be configured to communicate via a network 110 with various devices such as, for example, the server computer 115 and the cloud computer 155. The server computer 115 and the cloud computer 155 may be configured to provide to the driver assistance system 150, information about various establishments and/or location information (GPS coordinates, for example) of drive-through lanes in various establishments. In some applications, the driver assistance system 150 may be further configured to communicate with various infrastructure objects located outside the vehicle 125 by using vehicle-to-infrastructure (V2I) communications. In an example implementation, the driver assistance system 150 may use V2I communication to communicate with a smart pedestal at an entrance of an establishment (or inside the establishment), for obtaining various kinds of information, such as, for example, location information of a drive-through lane, traffic rules inside the establishment, a wait time, and a maximum speed limit on the premises of the establishment.

The network 110 may include any one, or a combination of networks, such as a local area network (LAN), a wide area network (WAN), a telephone network, a cellular network, a cable network, a wireless network, and/or private/public networks such as the Internet. For example, the network 110 may support communication technologies such as Wi-Fi, Wi-Fi direct, Ultra-Wideband (UBW), machine-to-machine communication, and/or man-to-machine communication.

At least one portion of the network 110 includes a wireless communication link (a WiFi link, for example), that allows the driver assistance system 150 and/or the infotainment system 135 of the vehicle 125 to communicate with the server computer 115 and/or the cloud computer 155. The network 110 may also support a wireless communication link (a cellular link, for example) that allows the server computer 115 and/or the cloud computer 155 to communicate with a personal communication device 121 carried by the driver 120 of the vehicle 125 (either when standing outside the vehicle 125 or seated inside the vehicle 125). The personal communication device 121 can be any of various devices such as, for example, a smartphone, a tablet computer, a phablet (phone plus tablet), a wearable computer, or a laptop computer.

The vehicle 125 may include various sensors and detection devices that are communicatively coupled to the driver assistance system 150 and/or the vehicle computer 145. A few examples of such sensors and detection devices can include a camera, an ultrasonic sensor, a radar sensor, a global positioning system (GPS) device, and a vehicle speed sensor. In the illustrated example, the detection devices include a camera 130, a camera 165, and a camera 140. The camera 130, which can be mounted on a rear-view mirror or a dashboard of the vehicle 125, is arranged to capture images of objects located in front of the vehicle 125. The camera 165, which can be mounted on a front bumper of the vehicle 125, is arranged to capture images of objects in front of the vehicle 125 including, for example, painted lane markings of a drive-through lane. The camera 140, which can be mounted on a rear bumper of the vehicle 125, is arranged to capture images of objects located behind the vehicle 125. In one implementation, the camera 130, the camera 165, and/or the camera 140 can be digital cameras that captures digital images and convey the digital images to the driver assistance system 150. In another implementation, the camera 130, the camera 165, and/or the camera 140 can be video cameras that capture video clips and/or streaming video and convey the video clips and/or streaming video to the driver assistance system 150. In another application, the camera 130, the camera 165, and/or the camera 140 can be night-vison cameras that capture images and/or video in low light conditions. In yet another application, the camera 130, the camera 165, and/or the camera 140 (along with additional cameras that are not shown) may be arranged to provide a 360° view around the vehicle 125. This arrangement allows image capture of multiple objects all around the vehicle 125, which are then conveyed to the driver assistance system 150.

The driver assistance system 150 may evaluate the images captured by the various cameras for various purposes such as, for example, to identify a landmark in an establishment having a drive-through lane, to identify a location of a drive-through lane with respect to one or more objects that may be present in the vicinity of the drive-through lane, and/or to identify lines painted on the ground inside or outside a drive-through lane.

In an exemplary embodiment in accordance with the disclosure, the driver 120 may drive the vehicle 125 into an establishment such as, for example, a fast-food restaurant, in order to purchase a fast-food item, or a pharmacy in order to pick up a medication. The driver assistance system 150 may detect the entry of the vehicle 125 into the establishment in any of various ways including, for example, by way of GPS coordinates or by sensing a geofence 245 that has been predefined around the establishment. In one implementation, the geofence 245 may be generated by the driver assistance system 150 based on input received from the driver 120 via the infotainment system 135 or the personal communication device 121. If the geofence 245 was not already present, details pertaining to the geofence 245 may be archived for future use by the driver assistance system 150 when the driver 120 revisits the establishment.

After entering the establishment, the driver assistance system 150 may automatically locate a drive-through lane. The drive-through lane may be detected in any of various ways such as, for example, by using GPS coordinates obtained from a database of the driver assistance system 150, or by detecting an infrastructure object and using a positional relationship between the infrastructure object and the drive-through lane. In an example scenario wherein a positional relationship is used, the driver assistance system 150 may evaluate an image captured by a camera on the vehicle 125 (the camera 130, for example) and detect a signboard. The driver assistance system 150 may then obtain data from a database of the driver assistance system 150 (or the server computer 115, or the cloud computer 155) that provides an example positional relationship between the signboard and the drive-through lane as follows: “10 meters north-east of the signboard.” In another example scenario, the driver assistance system 150 may evaluate an image captured by a camera on the vehicle 125 (the camera 130, for example) and detect a sign having an arrow that points towards the drive-through lane. The driver assistance system 150 may further evaluate the image to identify a direction in which the arrow is pointing and cooperate with the vehicle computer 145 to move the vehicle to an entry point of the drive-through lane.

When the vehicle 125 reaches the entry point of the drive-through lane, the driver assistance system 150 may instruct the driver 120 to take his/her hands off the steering wheel and feet off the brake pedal and the accelerator pedal. In another case, the driver assistance system 150 may instruct the driver 120 to carry out these actions, prior to the vehicle 125 reaching the drive-through lane, such as, for example, upon detecting a geofence surrounding the establishment or upon entry of the vehicle 125 into an entrance of the establishment.

The driver assistance system 150 may ensure that the driver 120 is no longer touching any vehicle driving components of the vehicle 125 before proceeding to carry out actions pertaining to autonomously directing travel of the vehicle 125 through the drive-through lane. Such actions may include initiating a stop-and-go mode of movement of the vehicle 125 through the drive-through lane, setting a speed limit of travel of the vehicle 125 through the drive-through lane, and avoiding colliding with other vehicles that may be present in the drive-through lane.

In another exemplary embodiment in accordance with the disclosure, the driver 120 may drive the vehicle 125 into an establishment having a drive-through lane and may initiate hands-off travel of the vehicle 125 through the drive-through lane by using the HMI on the infotainment system 135 or by using the personal communication device 121. The driver 120 may then either voluntarily, or in response to a prompt from the driver assistance system 150, take his/her hands off the steering wheel of the vehicle 125 and his/her feet off the brake pedal and accelerator pedal of the vehicle 125. The driver assistance system 150 may then execute actions such as the ones described above (identifying an entry point to the drive-through lane, initiating a stop-and-go mode of movement of the vehicle 125 through the drive-through lane, setting a speed limit of travel of the vehicle 125 through the drive-through lane, avoiding colliding with other vehicles that may be present in the drive-through lane, etc.).

In yet another exemplary embodiment in accordance with the disclosure, where the vehicle 125 is an autonomous vehicle, the driver assistance system 150 may automatically execute actions for driving through the drive-through lane without providing driver-related instructions.

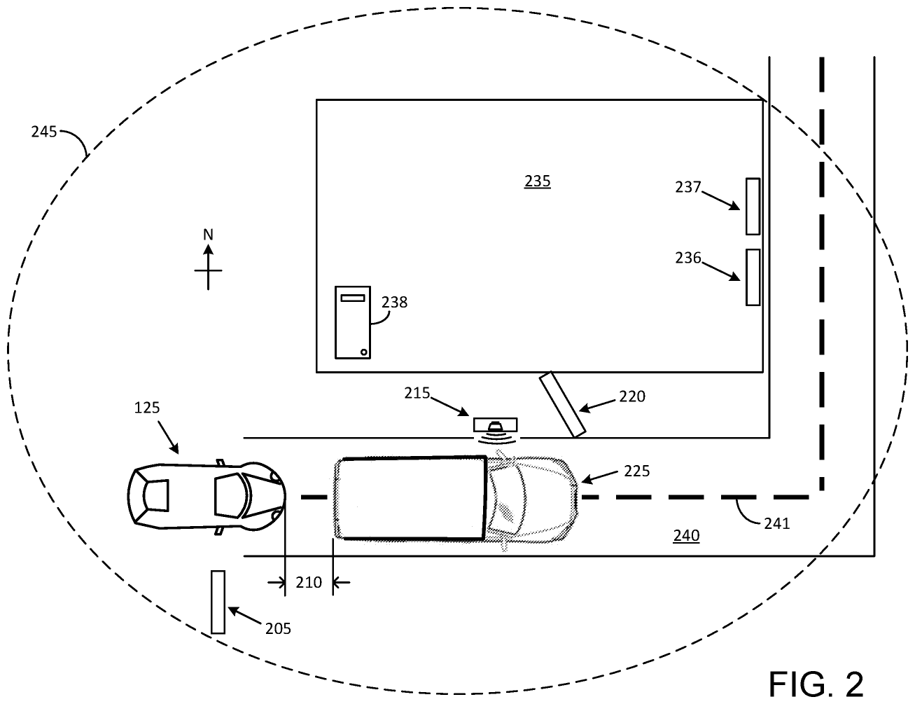

FIG. 2 illustrates an example scenario where the vehicle 125 executes an autonomous movement through a drive-through lane 240 of an establishment in accordance with an embodiment of the disclosure. In the illustrated scenario, the establishment is a fast-food restaurant that includes a building 235 configured to provide service to customers who opt to use the drive-through lane 240. A first portion of the drive-through lane 240 runs substantially parallel to a south wall of the building 235. An ordering station 215 that houses a speaker and a microphone for taking orders from drive-through customers is located adjacent to this portion of the drive-through lane. A menu board 220, which is located adjacent to the ordering station 215, displays a list of items that can be ordered by customers via the ordering station 215.

A second portion of the drive-through lane 240 runs substantially parallel to an east wall of the building 235. A payment window 236 is located in the east wall and configured to accept payment from customers who have ordered items via the ordering station 215. In one implementation, the payment may be accepted by an employee of the establishment (cash, credit card etc.). In another implementation, a customer may use an automated teller machine (ATM) to complete a payment. In yet another implementation, the payment may involve an over-the-air payment transaction where a payment system that is a part of the driver assistance system 150 wirelessly communicates with a payment kiosk located inside the building 235 to execute a payment.

A pickup window 237 is also located in the east wall north of the payment window 236. The pickup window 237 is configured such that an employee of the establishment can deliver items to customers who have paid for the items at the payment window 236.

In the illustrated example scenario, the vehicle 125 is located in the drive-through lane 240 behind a vehicle 225 that is pulling up (or is stopped) at the ordering station 215. The driver assistance system 150 has placed the vehicle 125 in a hands-off driving mode of operation for autonomously moving the vehicle 125 through the drive-through lane.

In an example procedure, the driver assistance system 150 may autonomously move the vehicle 125 through the drive-through lane based on evaluating images captured by one or more cameras. The images may be evaluated for identifying objects such as, for example, a painted median line 241, a welcome sign 205, the ordering station 215, and the menu board 220. The location of the objects and the characteristics of the objects (direction arrows, for example) may be used by the driver assistance system 150 as landmarks for locating and entering the drive-through lane 240. Such landmarks may be used together with images of painted lane markings such as the painted median line 241 and images of vehicles such as the vehicle 225 to ensure that the vehicle 125 stays within a lane boundary of the drive-through lane 240 and follows bends and turns of the drive-through lane 240 (such as, for example, the left turn prior to moving to the payment window 236). The painted median line 241 may be used by the driver assistance system 150 for lane centering operations so as to ensure that the vehicle 125 stays in the center of the drive-through lane 240, follows the bends, turns, and curves of the drive-through lane 240, and avoids colliding with objects outside the drive-through lane 240. The lane centering operation may be carried out by using the painted median line 241 without the need for additional lane boundary markings such as may be present in a multi-lane highway.

In another example procedure, the driver assistance system 150 may autonomously move the vehicle 125 through the drive-through lane based on information received from one or more of computers such as, for example, a computer 238 located in the establishment, the server computer 115, and the cloud computer 155. The information (maps, images, GPS coordinates, etc.) may be used by the driver assistance system 150 to identify, enter, and/or travel through the drive-through lane 240.

In another example procedure, the driver assistance system 150 may utilize machine learning to identify and to store information pertaining to the establishment and the drive-through lane 240. The information can include, for example, location information of the drive-through lane 240, location information of various landmarks in the establishment, and information about the layout of the establishment (such as, for example, the ordering station 215, the menu board 220, the payment window 236, and the pickup window 237).

When driving through the drive-through lane 240, the driver assistance system 150 sets a speed limit of travel in accordance with posted limits and/or in accordance with driving safety. In an example implementation, the driver 120 of the vehicle 125 may provide instructions for setting the speed limit (via the HMI of the infotainment system 135) and may also be permitted to override or modify the speed limit based on a personal judgment of the driver 120. The override command may allow the driver 120 to assume full control of the vehicle 125. In the illustrated example, the speed limit may be set so as to consistently provide a minimum separation gap 210 between the vehicle 125 and the vehicle 225. The minimum separation gap 210 may be determined by factors such as, for example, the number of vehicles ahead of the vehicle 125 in the drive-through lane 240 (in this case, one vehicle, in other cases, multiple vehicles), the speed of travel of the various vehicles, and/or braking by one or more of the other vehicles. The minimum separation gap 210 may be maintained by the driver assistance system 150 based on signals received from one or more sensors such as, for example, an ultrasonic sensor provided in a front bumper of the vehicle 125.

Other types of signals received from various sensors may be used to perform various other types of functions. For example, a signal from a light sensor may be used by the driver assistance system 150 to determine that the vehicle 125 is in the drive-through lane 240 at night, and to automatically turn off the headlights of the vehicle 125 so as to avoid dazzling the driver of the vehicle 225. As another example, audio signals received through a microphone of the infotainment system 135 or the personal communication device 121, for example, may be interpreted by the driver assistance system 150 and used for controlling certain actions of the vehicle 125. In an example scenario, the driver 120 may indicate via spoken language that the driver 120 has completed placing an order at the ordering station 215 (“Proceed to payment window” “Move ahead”, etc.), has completed payment (“Ready to move to pickup window” etc.), wishes to stay at a spot a bit longer (“Stop here”), or to leave (“Exit this place.”). In the case where the vehicle 125 is an autonomous vehicle, the input may be provided by an occupant of the autonomous vehicle in lieu of the driver 120.

As yet another example, signals received from the computer 238 or from smart devices in the establishment may be used by the driver assistance system 150 for executing certain actions. The signals received from the smart devices can be formatted in an infrastructure-to-vehicle (I2V) communication format, for example.

An example signal received from the computer 238 may indicate to the driver assistance system 150 that order entry has been completed at the ordering station 215 and the vehicle 125 can now move to the payment window 236. Another example signal received from an ATM device at the payment window may indicate to the driver assistance system 150 that payment has been completed and the vehicle 125 can move to the pickup window 237.

After completion of a transaction, which in this example scenario corresponds to a time after picking up an item at the pickup window 237, the driver assistance system 150 may display on the infotainment system 135 (or the personal communication device 121) a message that informs the driver 120 of the vehicle 125 that the autonomous movement of the vehicle 1225 through the drive-through lane 240 has been terminated and that the driver 125 can reclaim control of the vehicle 125.

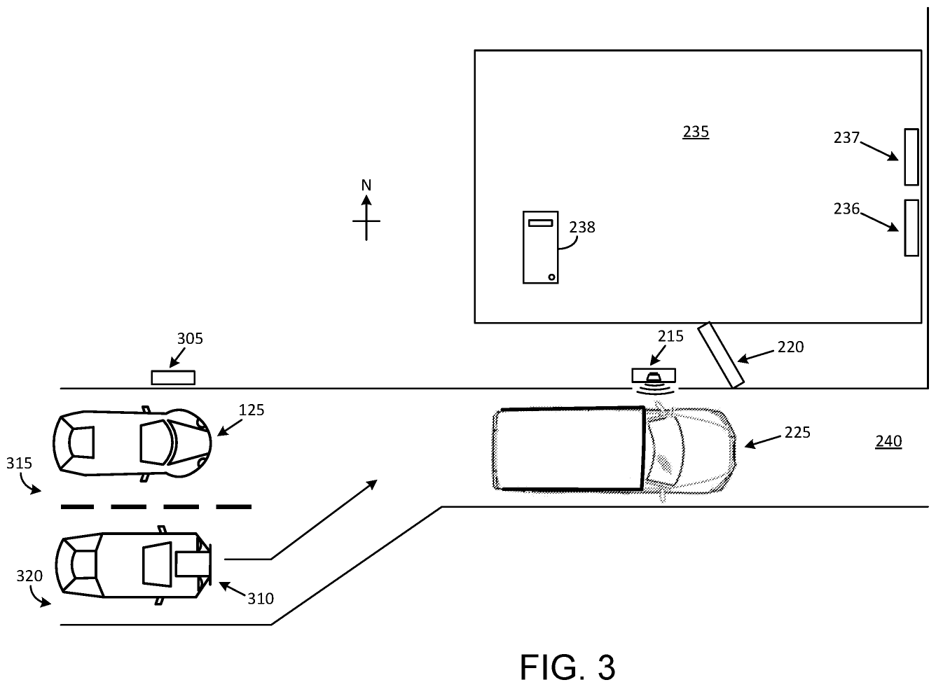

FIG. 3 illustrates another example scenario where the vehicle 125 travels through the drive-through lane 240 in accordance with an embodiment of the disclosure. In this example scenario, the drive-through lane 240 has a two-lane configuration that merges into a single-lane configuration. A vehicle 310 that is currently located in lane 320 may have arrived prior to the vehicle 125, which is located in lane 315. The driver assistance system 150 may, for example, evaluate an image captured by a camera mounted on the vehicle 125 and detect the presence, as well as the location, of the vehicle 310 in the lane 320. In an example procedure, the driver assistance system 150 may stop the vehicle 125 (and/or place the vehicle 125 in reverse if necessary), so as to allow the vehicle 310 to merge into the drive-through lane 240 ahead of the vehicle 125. The vehicle 125 may then follow the vehicle 310 in an autonomous stop-and-go mode of movement towards the ordering station 215.

In an example embodiment, the driver assistance system 150 may execute certain optional operations while the vehicle 125 is stopped or is moving slowly in either the lane 315 or in the drive-through lane 240. One such optional operation that may be performed by the driver assistance system 150 when the vehicle 125 is a battery electric vehicle (BEV) is a battery recharging operation. The battery recharging operation may be carried out in various ways such as, for example, by instructing the driver of the BEV to access a charging station 305 located in the vicinity of the lane 315 (or in any other lane of the drive-through lane 240). The driver of the BEV may manually couple a charging cable of the charging station 305 to a charging port in the BEV. In another implementation, the lane 315 and/or the drive-through lane 240 may include infrastructure elements (an embedded inductive charger circuit, for example) that automatically recharge a battery in the BEV via charge coupling when the BEV is stopped, or is moving over the embedded inductive charger circuit.

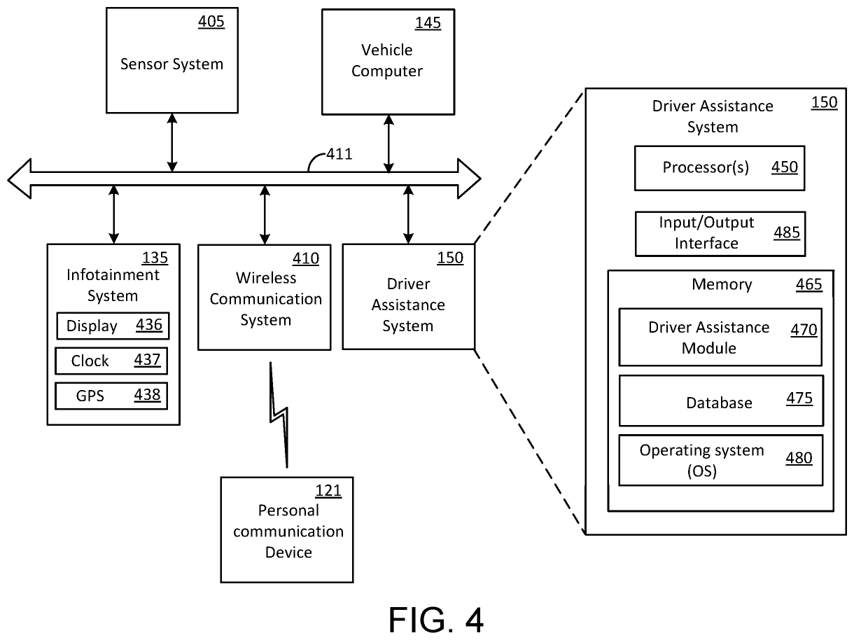

FIG. 4 shows some example components that may be provided in the vehicle 125 in accordance with an embodiment of the disclosure. The example components in the vehicle 125 can include a sensor system 405, the vehicle computer 145, the infotainment system 135, a wireless communication system 410, and the driver assistance system 150, which are communicatively coupled to each other via a bus 411. The bus 411 can be implemented using one or more of various wired and/or wireless technologies. For example, the bus 411 can be a vehicle bus that uses a controller area network (CAN) bus protocol, a Media Oriented Systems Transport (MOST) bus protocol, and/or a CAN flexible data (CAN-FD) bus protocol. Some or all portions of the bus 411 may also be implemented using wireless technologies such as Bluetooth®, ZigBee®, Ultra-Wideband (UWB), near-field-communications (NFC), cellular, Wi-Fi, Wi-Fi direct, machine-to-machine communication, and/or man-to-machine communication.

The sensor system 405 may include various sensors and detection devices that are communicatively coupled to the driver assistance system 150 and/or the vehicle computer 145. A few examples of such sensors and detection devices can include a camera, an ultrasonic sensor, a radar sensor, a global positioning system (GPS), and a vehicle speed sensor.

The wireless communication system 410 may include elements such as, for example, wireless transmitters and receivers that enable communications between the driver assistance system 150 and various devices, such as, for example, the personal communication device 121 of the driver 120, the cloud computer 155, and/or the server computer 115.

The infotainment system 135 can be an integrated unit that includes various components such as, for example, a radio, an MP3 player, a display 436, a clock 437, and a GPS device 438. The display 436 may include a graphical user interface (GUI) for use by the driver 120 to observe information and/or messages provided by the driver assistance system 150 (such as, for example, a message indicating that the driver assistance system 120 has placed the vehicle 125 in a stop-and-go mode of movement, an instruction to take hands off the steering wheel and legs off the brake and accelerator, a request for a voice instruction upon completion of an action such as placing an order or making a payment, and/or a message indicating that the driver assistance system 120 has terminated the stop-and-go mode of movement of the vehicle 125).

The driver assistance system 150 may include a processor 450, an input/output interface 485, and a memory 465. In some implementations, some or all parts of the driver assistance system 150 (such as, for example, the processor 450 and the memory 465), may be incorporated into the vehicle computer 145. The memory 465, which is one example of a non-transitory computer-readable medium, may be used to store an operating system (OS) 480 and various code modules such as, for example, a driver assistance module 470. The code modules are provided in the form of computer-executable instructions that can be executed by the processor 450 for performing various operations in accordance with the disclosure. More particularly, the driver assistance module 470 may be executed by the processor 450 for performing various operations in accordance with the disclosure. The input/output interface 485 may be configured to receive signals from various sensors of the sensor system 405, to receive location information (from the GPS device 438, for example), to receive information from the computer 238 of the establishment, to receive information from smart infrastructure elements, and to transfer information for display on the display 436 of the infotainment system 135 and/or on the personal communication device 121.

In an example driver assistance procedure, the processor 450 may cooperate with a processor of the vehicle computer 145 to perform various operations such as the example operations described above. The database 475 may be used to store various types of information such as, for example, location information of various establishments and geofence data.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 450 or the processor 510, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 465, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a processor, a location of a first vehicle in a drive-through lane of an establishment;
placing, by the processor and based on the first vehicle being in the drive-through lane of the establishment, the first vehicle in an autonomous mode of operation; and
enabling, by the processor, autonomous movement of the first vehicle through the drive-through lane in the autonomous mode of operation.

2. The method of claim 1, wherein enabling the autonomous movement of the first vehicle through the drive-through lane in the autonomous mode of operation comprises:
detecting, by the processor, a second vehicle located in front of the first vehicle; and
engaging, by the processor, a braking system of the first vehicle to avoid colliding with the second vehicle.

3. The method of claim 2, wherein enabling the autonomous movement of the first vehicle through the drive-through lane in the autonomous mode of operation further comprises:
placing, by the processor, the first vehicle in a stop-and-go mode of movement, the stop-and-go mode of movement including a speed limit of travel of the first vehicle through the drive-through lane.

4. The method of claim 1, wherein enabling the autonomous movement of the first vehicle through the drive-through lane in the autonomous mode of operation comprises:
detecting, by the processor, an infrastructure object in the establishment;
establishing, by the processor, a positional relationship between the infrastructure object and the drive-through lane;
determining, by the processor, a travel path through the drive-through lane based on the positional relationship; and
autonomously moving the first vehicle along the travel path.

5. The method of claim 4, wherein autonomously moving the first vehicle along the travel path comprises:
executing, by the processor, a lane-centering operation in the drive-through lane.

6. The method of claim 1, wherein determining the location of the first vehicle in the drive-through lane comprises:
identifying, by the processor, a geofence surrounding at least a portion of the drive-through lane; and
determining, by the processor, that the first vehicle is located inside the geofence.

7. The method of claim 1, wherein determining the location of the first vehicle in the drive-through lane is based on evaluating an image captured by a camera mounted on the first vehicle.

8. A method comprising:
detecting, by a processor, entry of a vehicle into a premises of an establishment having a drive-through lane; and
enabling, by the processor, autonomous movement of the vehicle through the drive-through lane.

9. The method of claim 8, wherein the vehicle is an autonomous vehicle and wherein enabling the autonomous movement of the vehicle through the drive-through lane comprises:
placing, by the processor, the autonomous vehicle in a stop-and-go mode of movement, the stop-and-go mode of movement including a speed limit of travel of the autonomous vehicle through the drive-through lane.

10. The method of claim 8, wherein the vehicle is an autonomous vehicle and wherein enabling the autonomous movement of the vehicle through the drive-through lane comprises:
identifying, by the processor, a travel path for moving the autonomous vehicle through the drive-through lane; and
placing, by the processor, the autonomous vehicle in a stop-and-go mode of movement, the stop-and-go mode of movement including a lane-centering operation while moving in the drive-through lane.

11. The method of claim 8, wherein the vehicle is operated by a driver and the method further comprises:
advising, by the processor, the driver of the vehicle to refrain from touching at least a first component of the vehicle; and
enabling, by the processor, the autonomous movement of the vehicle through the drive-through lane subject to the driver placing the vehicle in a hands-off driving mode of operation.

12. The method of claim 8, wherein the vehicle is operated by a driver and the method further comprises:
placing, by the processor, the vehicle in a stop-and-go mode of movement; and
instructing, by the processor, the driver of the vehicle to allow the vehicle to move autonomously through the drive-through lane.

13. The method of claim 12, wherein allowing the vehicle to move autonomously through the drive-through lane includes refraining from touching components that include a steering wheel of the vehicle, a brake pedal of the vehicle, and an accelerator pedal of the vehicle.

14. The method of claim 12, wherein placing the vehicle in the stop-and-go mode of movement comprises:
identifying, by the processor, a geofence surrounding at least a portion of the drive-through lane; and
placing, by the processor, the vehicle in the stop-and-go mode of movement upon determining that the vehicle is located inside the geofence.

15. A vehicle comprising:
a driver assistance system comprising:
a memory containing computer-executable instructions; and
a processor configured to access the memory and execute the computer-executable instructions to perform operations comprising:
determining a location of the vehicle in a drive-through lane of an establishment;
placing the vehicle in an autonomous mode of operation when traveling through the drive-through lane; and
enabling an autonomous movement of the vehicle through the drive-through lane in the autonomous mode of operation.

16. The vehicle of claim 15, wherein placing the vehicle in the autonomous mode of operation comprises issuing an instruction to a driver of the vehicle to refrain from touching components that include a steering wheel of the vehicle, a brake pedal of the vehicle, and an accelerator pedal of the vehicle.

17. The vehicle of claim 15, wherein the autonomous movement of the vehicle through the drive-through lane in the autonomous mode of operation includes traveling under a speed limit.

18. The vehicle of claim 15, wherein the processor is configured to access the memory and execute additional computer-executable instructions to perform operations comprising:
define a geofence surrounding at least a portion of the drive-through lane.

19. The vehicle of claim 18, further comprising a sensor system, and wherein the processor is configured to access the memory and execute additional computer-executable instructions to perform operations comprising:
identifying, based on information received from the sensor system, the drive-through lane inside the geofence; and
placing the vehicle in the autonomous mode of operation upon entry of the vehicle into the drive-through lane.

20. The vehicle of claim 15, further comprising a camera, and wherein the processor is configured to access the memory and execute additional computer-executable instructions to perform operations comprising:
identifying, based on a first image received from the camera, the drive-through lane of the establishment;
identifying, based on a second image received from the camera, an entry of the vehicle into the drive-through lane of the establishment; and
placing the vehicle in the autonomous mode of operation upon entry of the vehicle into the drive-through lane of the establishment.
